(19) United States
(12) Patent Application Publication
(10) Pub. No.: US 2008/0261480 A1
(43) Pub. Date: Oct. 23, 2008

(54) Interactive money box and child thrift method

(76) Inventor: Chi Wai Chan, New Territories (CN)

Correspondence Address: ALIX YALE & RISTAS LLP, 750 MAIN STREET, SUITE 1400, HARTFORD, CT, 06103, US

(21) Appl. No.: 11/787,550

(22) Filed: Apr. 17, 2007

(51) Int. Cl. G06Q 40/00

(52) U.S. Cl. 446/9

(57) ABSTRACT

An interactive money box fosters the habit of saving in children by displaying animated characters in response to insertion of coins into a money box. Characters may also be displayed in response to failure to insert coins for a period of time or at a given rate.

### BACKGROUND

A number of devices and techniques have been advanced to encourage and facilitate saving money by children. In addition to traditional piggy banks, more sophisticated mechanical and electronic devices which supplement and encourage children in the habit of saving have been introduced.

It has been known that children are attracted to and identify with various animated characters in a very positive manner. Children are also adept at interacting with electronic devices.

### SUMMARY

The device and method disclosed herein provides children with an interesting and interactive way to develop the habit of saving. When a child inserts a coin into the money box, a display on the money box shows a positive animated scenario to the child. The amount of coins inserted into the money box may also be calculated automatically. After a certain amount of money has been inserted, a child friendly creature will be displayed. The health condition of the animated creature will appear as a function of savings. If the child does not insert a coin for a pre-established time, the health condition of the animated creature will decline. If the frequency of insertion is below a certain threshold of savings, the animated creature may decline in demeanor and die. Numerous different creatures may be displayed in sequence. When a sufficient number of coins is deposited, a new one will appear, and the same sequential process of health demeanor will take place. All of the creatures may be collected in a collection which is also displayable to the child.

An interactive money box comprises a housing having a storage region and an opening which provides access to the storage region. A sensor detects insertion of a coin through the opening. An electronic display is mounted to the housing and visible from an exterior area location to the housing. A processor is responsive to the sensor and in communication with the electronic display. The display exhibits an animated virtual creature sequence in response to the frequency of insertion of a coin. An audio speaker in communication with the processor provides an associated audio output. The electronic display may be a dot matrix display.

In one embodiment, the electronic display and processor are configurable to function as an alarm clock. The creature sequence comprises a sequence wherein the health or demeanor of the creature is displayed as a function of the frequency of the insertion of a coin. The creature sequence may also comprise a sequence wherein a new creature appears after a certain level of savings. The virtual creatures may include different animated pets, such as fish. A collection of the animated pets may be displayed upon selective activation of one or more keys. A key may be employed to transform between an alarm clock and a bank mode. The processor includes a memory containing data for generating a multiplicity of different animated creatures.

A method for encouraging thrift comprises providing a container for money which has an opening. Signals indicative of the insertion of money into the opening are generated. The frequency of the signals is determined. An electronic display of an animated creature is displayed as a function of the frequency. The health condition of the animated creature is displayed as a function of the savings rate. When the frequency of coin insertion is greater than a certain threshold, a new version of an animated creature is selected and displayed. A sequence of different animated creatures is generated. A collection of the different creatures may be displayed. An audio sound is generated in association with the electronic display.

### BRIEF DESCRIPTION OF THE DRAWINGS

FIG. 1 is a perspective view, partly in schematic, of an interactive money box;

FIG. 2 is a top plan view of the interactive money box of FIG. 1;

FIG. 3 is a side view of the interactive money box of FIG. 1;

FIG. 4 is a rear view of the interactive money box of FIG. 1;

FIG. 5 is a side view, partially in phantom, of the interactive money box of FIG. 1;

FIGS. 6A-F are representative displays of virtual creatures employed in the interactive money box of FIG. 1;

FIG. 7 is a block diagram of the electronic system employed in the interactive money box of FIG. 1;

FIG. 8 is an operational block diagram for the interactive money box of FIG. 1; and

FIG. 9 is an electrical schematic diagram for the interactive money box of FIG. 1.

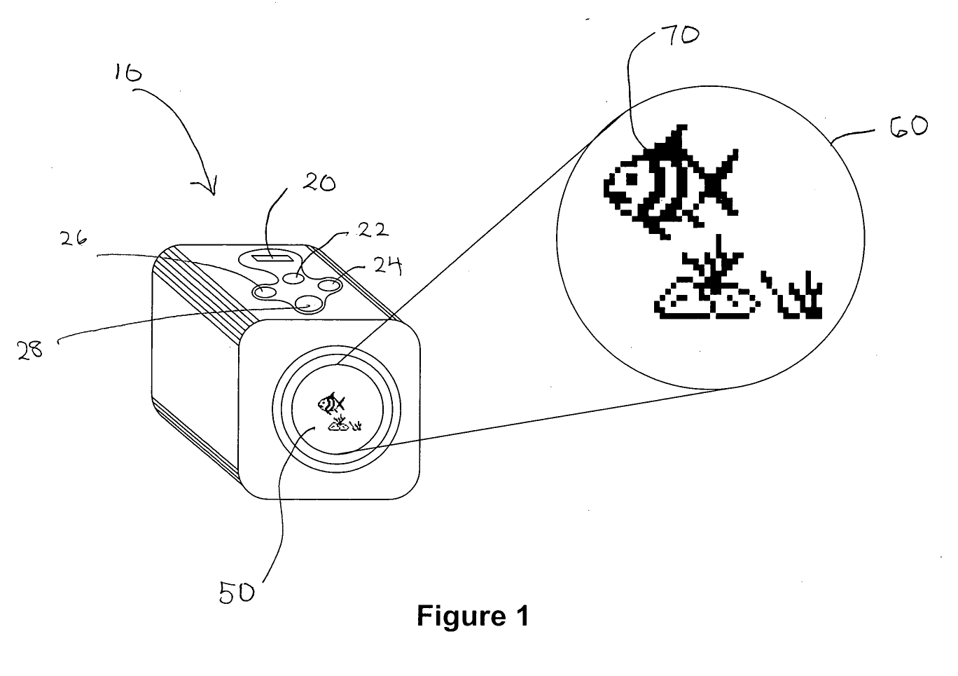

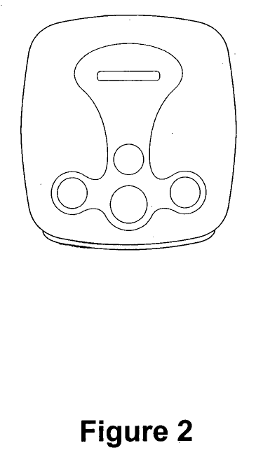

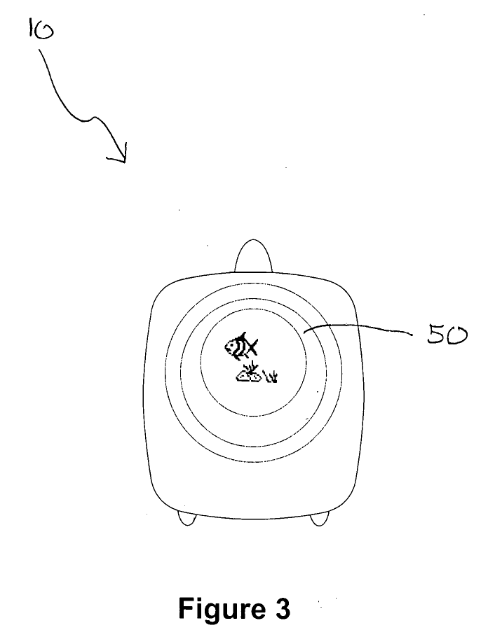

### DETAILED DESCRIPTION

An interactive money box designated generally by the numeral 10 has a sculpted aesthetically pleasing appearance and is especially adapted for use and enjoyment by children.

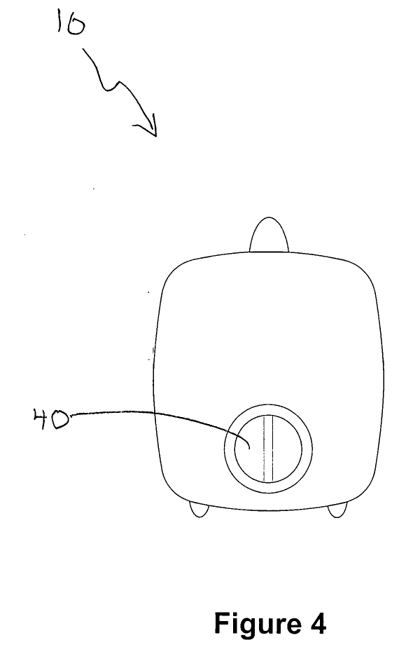

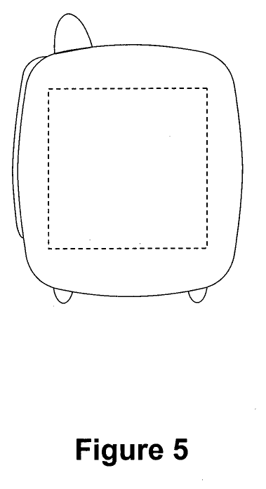

The money box 10 functions as an interactive piggy bank to encourage savings or thrift among young children. The money box 10 includes a coin slot 20 at an upper location. Various depressible keys 22, 24, 26 and 28 adjacent the coin slot are employed for operating the money box as will be described below. A storage area 30 at the interior of the money box receives and stores the inserted coins. A removable cover 40 (FIG. 4) at the opposing end of the money box can be removed for emptying the coins from the money box. An LCD display 50 provides an exterior animated image 60 as will be further described below.

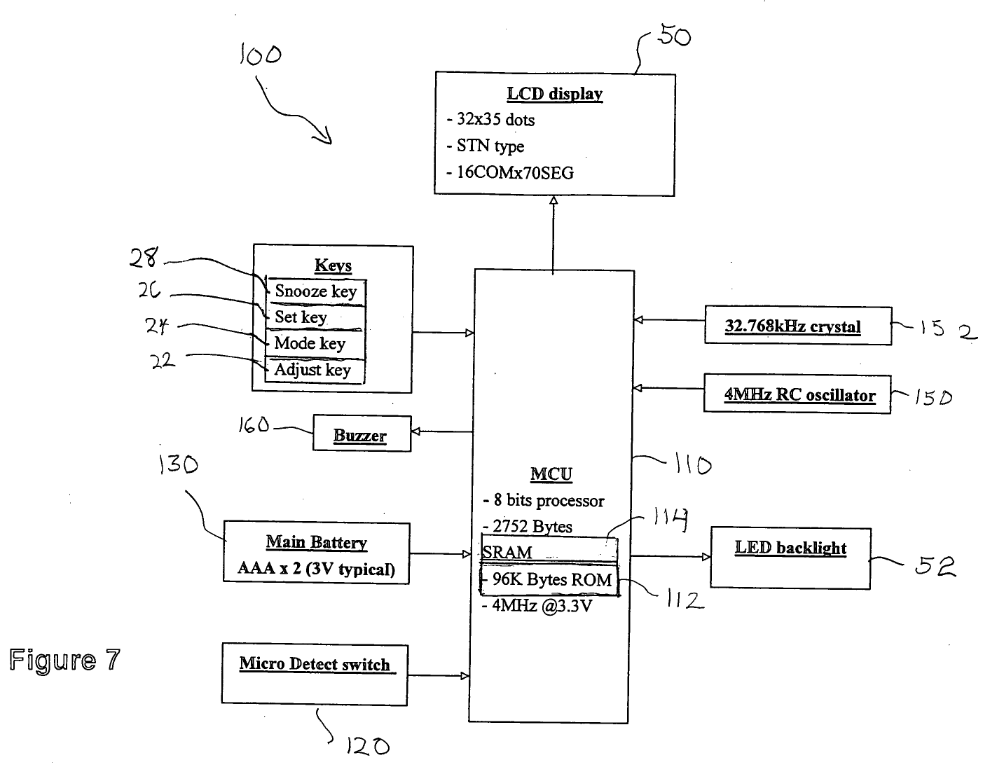

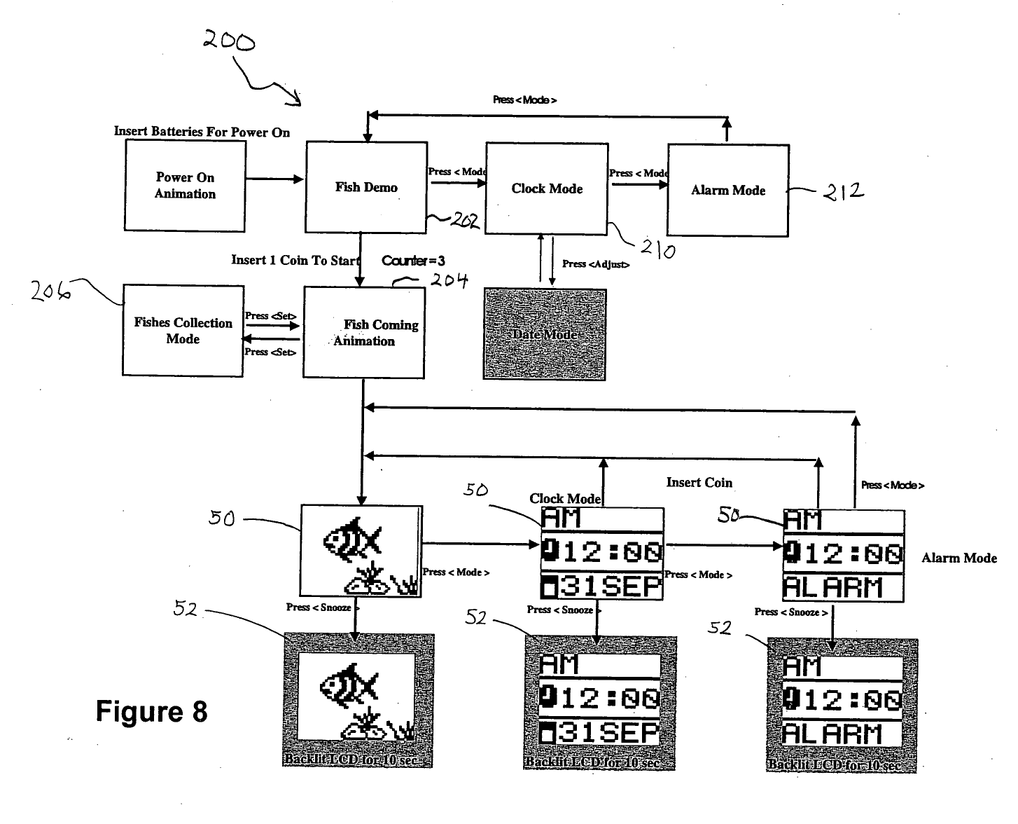

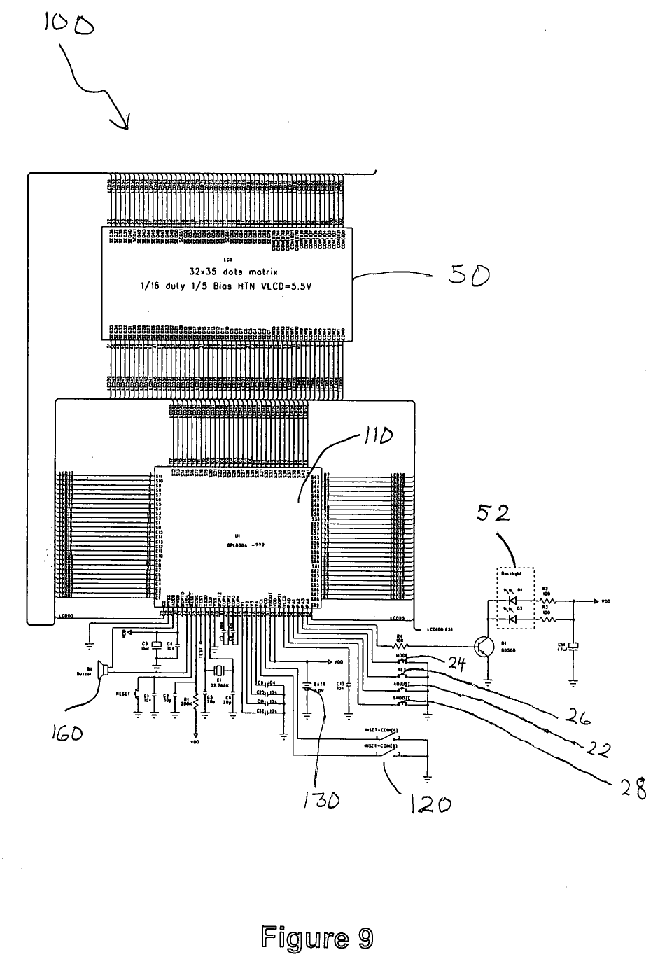

The money box 10 incorporates an electronic module 100 (FIGS. 7, 9) which interacts with the user to provide an educational experience for encouraging savings. In one preferred embodiment, the money box also incorporates an alarm clock as part of the electronic module 100. An operational diagram illustrating the alarm clock function and its relationship with the bank mode is illustrated in FIG. 8.

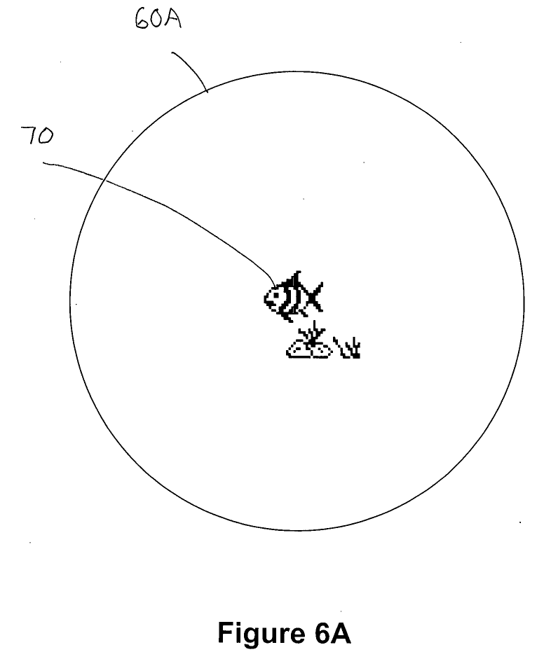

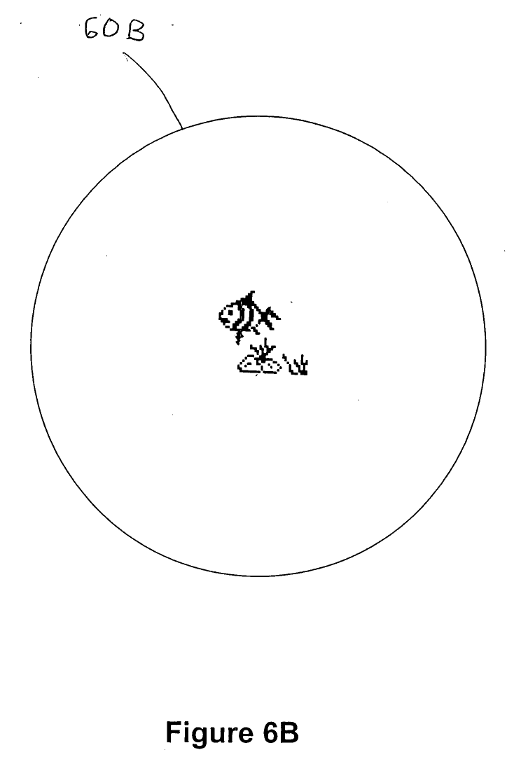

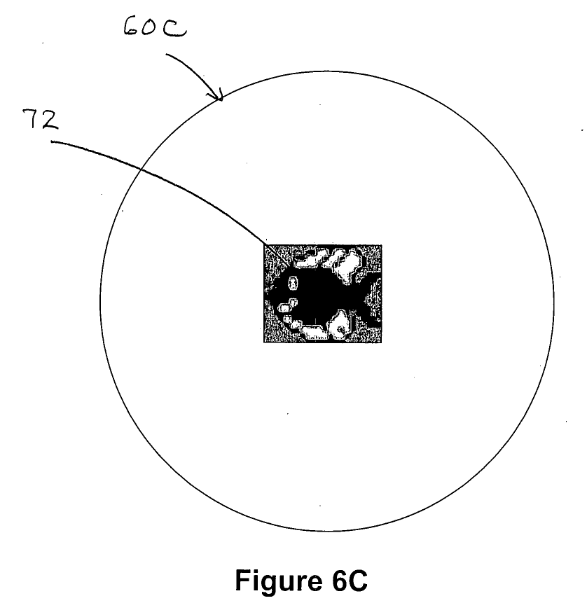

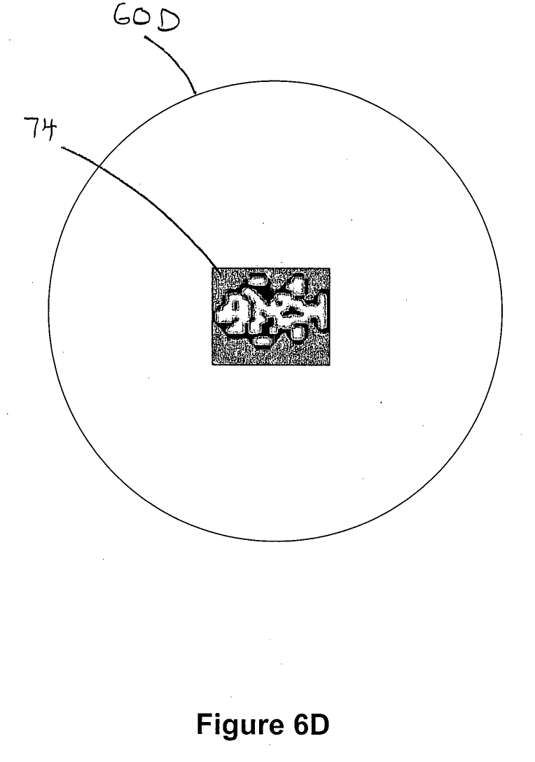

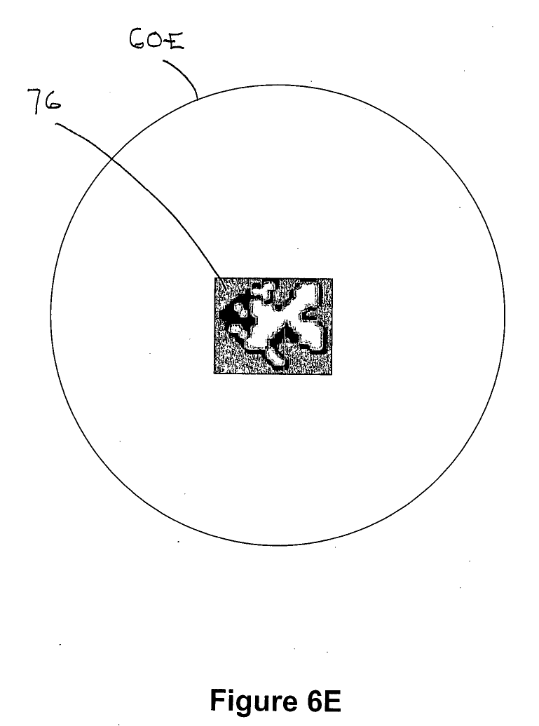

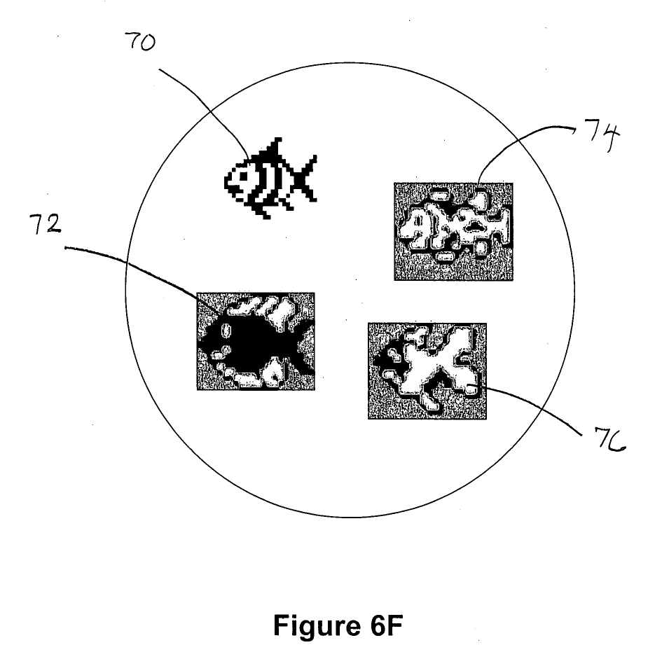

In general, the interactive money box functions to detect the insertion of coins (not illustrated) into the money box 10 via the slot 20. With reference to FIGS. 6A-E, in response to the insertion of coins at a given number and/or frequency, animated child friendly creatures 70 are displayed at the LCD display 50. As the savings rate is maintained at a desirable level (which may be measured in terms of frequency or aggregate number) various sequences of animated images 60, 60A, 60B, 60C, 60D, 60E . . . , such as cartoons of pets, are displayed at the LCD display 50. The virtual creatures 70, which in one representative example, is illustrated as a fish in FIG. 6A, would display a healthy demeanor as a function of insertion of coins into the coin slot 20 at a favorable savings rate. In the event that the savings rate is below a certain threshold or aggregate number, then the healthy demeanor of the creature 70 would diminish, such as 60B and in extremity would decline to the point the creature would die.

As the savings rate continues, new virtual creatures 72, 74, 76 . . . would be created and displayed. There may be as many as ten different creatures. In one embodiment, there are ten different species of fish. Other pets and animals such as cats and dogs may also be employed. The user would be able to push (or double push) a key, for example mode key 24 and set key 22, and view a collection (FIG. 6F) of all the virtual creatures 70, 72, 74, 76 which have been created by the savings. In addition to the visual display, the electronic module 100 would be capable of generating happy sounds as the savings rate increase, and neutral or unhappy sounds as the savings rate declines below a pre-established level.

With reference to FIG. 7, an electronic module 100 which incorporates an alarm clock employs a microprocessor control unit 110 for implementing software control. An internal ROM 112 stores the interactive software and related data. An internal RAM 114 stores the control data. An input to the MCU 110 functions as a user interface between the child and the money box. The output of the MCU 110 generates visual animation which is preferably accompanied with audio effects. The alarm clock function is optional.

A micro-detection switch 120 which detects the insertion of coins generates a signal to the MCU 110 to control the software interaction. The switch is positioned in the vicinity of the slot 20 of the money box. A battery pack 130 provides power to the module. The MCU is also responsive to various inputs, such as, for example, an adjust key 22, a mode key 24, a set key 26 and a snooze key 28. The keys are manually operated at the exterior top of the money box and provide the requisite inputs to the microcontroller unit MCU 110 for operating the interactive features, as well as the alarm clock. The MCU also receives input from a 4 MHz oscillator 150, and a 32.768 kHz crystal 152.

The MCU 110 generates an audio signal to a speaker 160 and/or signals to the LCD display 50. The speaker 160 may, in some embodiments, be in the form of a buzzer. The MCU is also capable of generating an LED backlight 52 to enhance the visual effect.

With reference to FIG. 8, a representative, operational diagram 200 is illustrated. The micro-detection switch 120 positioned at the opening of the money box to trigger the interaction to implement the appearance of the virtual creatures. Upon insertion of the coin through the slot 20, the micro-detection switch is triggered to trigger the interaction in the software to generate the appropriate display. For example, when children save money by the daily insertion of a coin, the creature displayed at LCD display 50 would show a healthy demeanor of the virtual creatures which, in an illustrated representation of FIGS. 6A and 60C-F, are fish.

In one embodiment, a switch 42 (FIG. 5) is employed to detect when the removable cover 40 is removed. The removal likely means money has been removed. The input from switch 42 then resets the creature currently to an initial status state. However, the old species would be retained for viewing purposes.

In a mode generated by the mode key 24, when the system is powered and a coin is inserted, the fish demo is triggered at 202, and the fish animation commences at 204 so that the fish from the fish collection at 206, are shown at the LCD display 50. In addition, the LCD may be backlit at 52, for example, for 10 seconds. The mode key 24 changes the mode and is employed to select the creature, time or alarm mode. In the creative mode, the set key 22 is present to select a current creature or a creature collection mode. Upon pressing the set key 22, a user may view a collection of all of the various pets, such as different species of fish represented in FIG. 6F produced during the historical saving period.

The system is also integrated with a clock mode at 210 and an alarm mode at 212 which may be implemented through the mode key 24 and adjusted by pressing the adjust key 26. the set key 22 sets the settings and confirms same. The clock mode at LCD display 50 would be illustrated by pressing the mode key 24. In the normal mode, the clock display would be backlit, for example, for 10 seconds (or other time interval) by pressing the snooze key 28. The snooze key 28 also sets the snooze function for the alarm clock. The alarm mode could also be triggered by mode key 24, and upon the alarm being generated, would be backlit for 10 seconds, for example.

The display 50 may alternatively be a 32 by 35 dot matrix or other suitable electronic display responsive to the microprocessor MCU 110.

While preferred embodiments of the interactive money box and the child thrift method are set forth for purposes of description, the foregoing description should not be deemed a limitation of the invention herein. Accordingly, various modifications, adaptations and alternatives may occur to one skilled in the art without departing from the spirit and scope of the present invention.

What is claimed:

1. An interactive money box comprising:
a housing having a storage region and an opening which provides access to said storage region;
a sensor to detect the insertion of a coin through said opening;
an electronic display mounted to said housing and visible from an exterior location to said housing; and
a processor responsive to said sensor and in communication with said electronic display so that the display exhibits an animated virtual creature sequence in response to the frequency of insertion of a coin.

2. The interactive money box of claim 1 further comprising an audio speaker in communication with said processor and providing an audio output.

3. The interactive money box of claim 1 wherein said electronic display is a dot matrix display.

4. The interactive money box of claim 1 wherein said electronic display and processor are configurable to function as an alarm clock.

5. The interactive money box of claim 1 wherein said creature sequence comprises a sequence wherein a creature changes in illustrated health demeanor.

6. The interactive money box of claim 5 wherein said illustrated health demeanor is a function of rate of coin insertion.

7. The interactive money box of claim 1 wherein said virtual creature sequence comprises a plurality of different animated pets.

8. The interactive money box of claim 7 further comprising displaying a collection of each of said pets.

9. The interactive money box of claim 4 and further comprising a key for transforming between alarm clock and bank modes.

10. The interactive money box of claim 1 wherein said processor comprises a memory containing data for generating a multiplicity of different animated creatures.

11. A method for encouraging thrift comprising:
providing a container for money, said container having an opening;
generating signals indicative of the insertion of money into said opening;
determining the frequency of said signals; and
displaying one or more animated creatures as a function of said frequency.

12. The method of claim 11, wherein said animated creatures further comprise different virtual pets.

13. The method of claim 11, further comprising generating a sequence of depictions having different illustrated health demeanors for each creature.

14. The method of claim 11, wherein when said frequency is greater than a threshold, selecting a new animated creature and further displaying the new creature.

15. The method of claim 11, further comprising sequentially generating a plurality of sequences of different animated pets.

16. The method of claim 15, further comprising displaying a collection of pets from said plurality of sequences.

17. The method of claim 11, further comprising generating an audio sound in association with said electronic display.

18. The method of claim 11, further comprising sequentially displaying different species of a pet.
